(19) United States
(12) Patent Application Publication
(10) Pub. No.: US 2006/0213566 A1
(43) Pub. Date: Sep. 28, 2006

(54) VACUUM INSULATED EXHAUST SYSTEM

(76) Inventor: David J Johnson, Woodbridge, Ontario (CA)

Correspondence Address: GREGORY J. GORE, 70 WEST OAKLAND AVENUE, SUITE 316, DOYLESTOWN, PA, 18901, US

(21) Appl. No.: 11/308,323

(22) Filed: Mar. 16, 2006

Related U.S. Application Data
(60) Provisional application No. 60/664,962, filed on Mar. 25, 2005.

(51) Int. Cl. F16L 9/18

(52) U.S. Cl. 138/111

(57) ABSTRACT

A double-walled exhaust pipe is used with an internal combustion engine and includes a first elongate outer tube and a second elongate inner tube positioned concentrically within the outer tube and affixed at the ends. A chamber is created between the inner and outer tubes which extends substantially their entire length and is sealed against the atmosphere by welding at the ends of the tubes. A one-way valve is affixed to the outer tube and in fluid communication with the chamber so that a vacuum having a negative pressure at least 20 inches of mercury can be drawn. The outer tube preferably has a greater wall thickness than the inner tube.

### RELATED APPLICATION

The present application is related to provisional patent application Ser. No. 60/664,962 entitled “Vacuum Insulated Exhaust System” filed on Mar. 25, 2005, priority from which is hereby claimed.

### FIELD OF THE INVENTION

The present invention relates to vehicle exhaust systems and more specifically to a double-walled exhaust pipe useful for sound abatement and heat retention in the exhaust flow of an internal combustion engine to enhance the performance of exhaust pollution control devices.

### BACKGROUND OF THE INVENTION

Exhaust gas temperature is critical to the efficient operation of pollution control devices such as catalytic converters and particulate traps which are well known in the automotive industry. Different improvements have been tried to maximize heat retention with exhaust gases delivered to the pollution control device such as adding insulation to the exhaust pipe or to draw a small vacuum in the space between the double-walled pipe such as taught in U.S. Pat. No. 3,457,723 issued to Kerns. Wrapping the exhaust pipe is bulky and cumbersome and requires maintenance. The vacuum of Kerns is supplied only by the minimal negative intake manifold pressure and therefore is insufficient to be significantly effective. These attempts have provided only minimal benefits and neither has been applied to diesel engines with any great success.

### SUMMARY OF THE INVENTION

In order to meet the needs in the art as explained above, the present double-walled exhaust system has been devised. The present exhaust system utilizes a thin, stainless steel inner tube positioned inside a thicker stainless steel outer tube without the two tubes touching at any point except at their ends. The ends are mated by swaging the inner tube to meet the inside diameter of the outer tube. The swaged ends are then welded to create an airtight seal thus providing an enclosed chamber between the tubes. High temperature, one-way valves are fitted through the outer tube in fluid communication with the intra-tube chamber. The chamber is then flooded with an inert gas such as nitrogen to replace the denser atmosphere inside the chamber. The inert gas is then vacuumed out of the chamber through one of the one-way valves to create a sustained vacuum within the chamber. The valves are then sealed over with secondary leakproof caps.

More specifically, the applicant has devised a double-walled exhaust pipe for use with an internal combustion engine comprising a first elongate outer tube with a second elongate inner tube positioned concentrically within the outer tube and affixed to it only at each of its ends. This construction creates a chamber between the inner and outer tubes which extends substantially their entire length. Welding at the ends of the tubes seals the chamber against the atmosphere. At least one one-way valve is affixed to the outer tube and is in fluid communication with the chamber so that a vacuum having a negative pressure of at least 20 inches of mercury can be drawn. Preferably two one-way valves, one at each end of the exhaust pipe, are installed. The tubes are preferably separated by a distance of between 0.25 and 0.50 inches. To facilitate bending and reduce the overall weight of the assembly, the outer tube preferably has a greater wall thickness than the inner tube. In use, the pipe is affixed between the exhaust manifold of an internal combustion engine such as a diesel engine and the opposite end is connected to a pollution control device such as a catalytic reactor or a particulate trap.

This structure provides a surprisingly high degree of exhaust gas heat retention and sound abatement. The heat retention is achieved by slowing down the natural heat transfer process across the length of the tube to keep the exhaust gas' temperature at the outlet close to the same temperature as at the inlet. The vacuum chamber eliminates heat transfer through the walls of the exhaust tube and also, because sound is a mechanical wave not transmitted through a vacuum, the exhaust noise is abated.

It is therefore the main object of the invention to produce an insulated exhaust pipe by use of a double-walled exhaust pipe having a vacuum chamber which results in thermal and sound insulation of the exhaust gases. It is another object of the invention to create an insulated exhaust pipe for use in combination with a pollution control device to increase the exhaust gas temperature delivered to the device to increase its efficiency.

From the following drawings and description of the preferred embodiment, it will be appreciated by those of skill in the art that the objects of the invention have been achieved. While the present invention will be described with the reference to a specific embodiment, the following description is illustrative of the invention and is not to be construed as limiting the invention. Various modifications to the present invention can be made to the preferred embodiment by those skilled in the art without departing from the true spirit and scope of the invention. It will be noted here that for better understanding like components are designated by the reference numerals throughout the various figures of drawing which follow.

### BRIEF DESCRIPTION OF THE DRAWINGS

FIG. 1 is a side view of a double-walled exhaust pipe constructed according to the invention.

FIG. 2 is a graph showing the heat retention performance of the invention compared with a standard exhaust system.

### DESCRIPTION OF THE PREFERRED EMBODIMENT

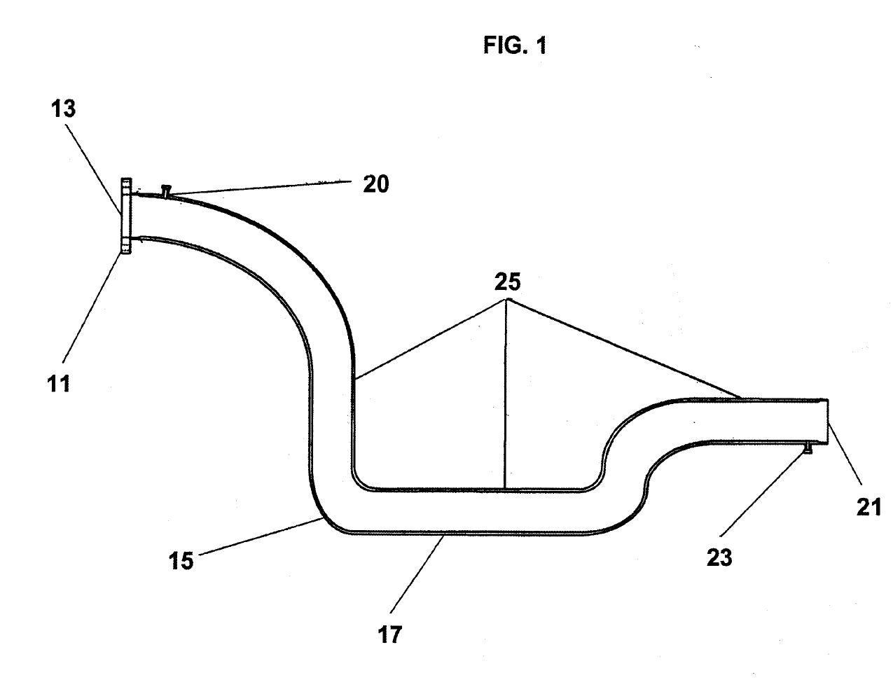

Referring now to FIG. 1, the present double-walled exhaust pipe of the invention is depicted. The exhaust pipe begins with the manifold inlet flange 11 at one end being an engine exhaust inlet 13. Typically the flange is bolted to the engine block. The flange is welded at the inlet end of the pipe where at the inner tube 15 it has been swaged and welded to the outer tube 17. Similarly, at an exhaust outlet 21 the tubes are swaged and welded. This creates a vacuum chamber 25 between the inner and outer tubes which extends substantially along their entire length. One-way valves 20 and 23 with leakproof caps are secured through the outer pipe, one at each end of the exhaust pipe. The exhaust outlet is typically connected to a pollution control device such as a catalytic reactor or a particulate trap, neither of which is shown in this figure.

Constructing the present invention requires making complex bends to the double-wall tube while maintaining a predetermined separation between the tubes. Maintaining this distance is critical since any points of contact between the two tubes will diminish the insulation quality of the vacuum chamber. Construction is preferably carried out in the following steps.

First, an inner tube of an appropriate diameter consisting of a thin-walled, stainless steel material is selected. An outer tube consisting of a thicker-walled stainless steel material is then also selected to be between 0.25 and 0.50 inches greater in diameter. Next, the inner tube is placed inside of the outer tube and the inner tube swaged at one end to meet the corresponding end of the outer tube. The two tubes are then solid welded at the swaged end and held vertically with the welded swaged end at the bottom. Sand is then poured into the chamber between the tubes and vibrated until it is filled close to the top. Next, at the open top end, the inner tube is swaged to meet the outer tube and the two tubes welded at the second swaged end.

The finished, sand-filled double tube is then bent into the final shape using an ordinary mandrel bending machine. Once the correct bends have been achieved, the swaging of the second end is cut off and the sand removed from that end and reclaimed. The second end is then swaged again so that the inner tube meets the outer tube and then re-welded. Next, two quarter-inch holes are drilled into the outer tube, one at each opposite end, and a one-way valve welded into each of the holes. An appropriate engine manifold flange is then welded to an inlet end of the pipes. The chamber between the tubes is then purged with an inert gas such as nitrogen through one of the valves and pressurized to check for any leaks. Finally, a vacuum of −29.5 inches of mercury is drawn from one of the valves and a leakproof cap placed over each valve.

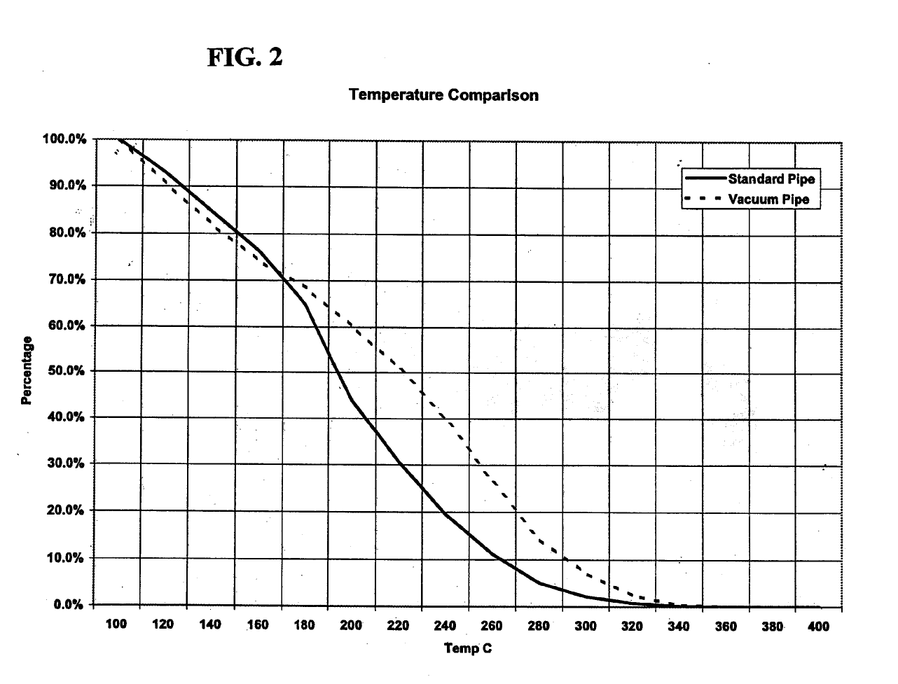

FIG. 2 is a graph which depicts the heat retention characteristics of the exhaust pipe compared with a standard exhaust pipe. The Y axis on the left side of the graph represents the distribution of temperature over time and the X axis across the bottom shows the temperature in degrees centigrade. All temperature measurements were taken at the muffler inlet location of a diesel truck during a typical driving route. Therefore, referring to the line which depicts the performance of an original muffler, the data indicates that the temperature taken at the inlet of the muffler is 125 degrees for 90 percent of the time; 150 degrees for 80 percent of the time; 175 degrees for 65 percent of the time, etc. The other line on this chart represents the muffler inlet temperature with the exhaust pipe replaced by the vacuum insulated exhaust pipe of the present invention.

As clearly shown by this chart, the temperature observed at the muffler inlet is increased significantly by the utilization of the present vacuum insulated exhaust pipe. The temperatures shown for the standard pipe are not sufficiently high for an after-treatment device such as a particulate reactor to function properly. Further tests have shown that in applications in which the diesel engine is turbo charged that an after-treatment device could be moved to the turbo charger output location and have the necessary temperature to function properly. This also enables the use of a higher performing after-treatment device which has significant health benefits.

It should be understood that there may be other modifications and changes to the present invention that will be obvious to those of skill in the art from the foregoing description, however, the present invention should be limited only by the following claims and their legal equivalents.

What is claimed is:

1. A double-walled exhaust pipe for use with an internal combustion engine, comprising:
a first elongate outer tube;
a second elongate inner tube positioned concentrically within said outer tube and affixed thereto only at first and second opposite ends thereof;
a chamber between said inner and outer tubes extending substantially their entire length and being sealed against the atmosphere; and
wherein said chamber has a negative pressure of at least 20 inches of mercury.

2. The exhaust pipe of claim 1 further including at least one one-way valve affixed to said outer tube and being in fluid communication between the surrounding atmosphere and said chamber.

3. The exhaust pipe of claim 2 including two one-way valves, one at each end of said exhaust pipe.

4. The exhaust pipe of claim 3 wherein said negative pressure is approximately 29.5 inches of mercury.

5. The exhaust pipe of claim 1 wherein said outer tube has a greater wall thickness than said inner tube.

6. The exhaust pipe of claim 1 wherein said pipe is positioned between and in fluid communication with the exhaust of an internal combustion engine at the first end and in fluid communication with a pollution control device at the second end.

7. The exhaust pipe combination of claim 6 wherein said pollution control device is a catalytic reactor.

8. The exhaust pipe combination of claim 6 wherein said pollution control device is a particulate trap.

9. The exhaust pipe combination of claim 6 wherein said internal combustion engine is a diesel engine.

10. The exhaust pipe of claim 1 wherein the diameter of said outer tube is in the range of 0.25 inches to 0.50 inches greater in diameter than said inner tube.

11. The method of constructing a double-walled exhaust pipe, comprising the steps of:
providing a first elongate outer tube;
providing a second elongate inner tube positioned concentrically within said outer tube;
affixing said inner tube and outer tube only at first and second ends thereof, there being no points of contact between the tubes;
creating a chamber sealed against the atmosphere in a space between said inner and outer tubes; and
drawing a vacuum in said chamber to a negative pressure of at least 20 inches of mercury.

12. The method of constructing a double-walled exhaust pipe, comprising the steps of:
providing a first elongate outer tube;
providing a second elongate inner tube positioned concentrically within said outer tube;
aligning the tubes axially;
joining the inner tube to the outer tube at a first end of the pipe by swaging;
welding said tubes together at said first end along said swaged joint;
orienting said tubes vertically with the first end at the bottom;
introducing sand into the space between the tubes through a second end of the pipe as the tubes are vibrated;
joining the tubes at the second end by swaging and welding them along said swaged joint;
bending the sand-filled double tube;
cutting off the welded second end;
removing sand from the space between the tubes through the second end;
joining the inner tube to the outer tube at the second end by swaging and welding them along said swaged joint; and
welding one-way valves into the outer tube, one at each end of the pipe, each of said valves being in fluid communication between the space between the tubes and the surrounding atmosphere.

13. The method of constructing an exhaust pipe of claim 12 further including the step of welding an engine manifold flange to said first end of the pipe.

14. The method of claim 13 including the additional step of purging the space between the tubes by introducing an inert gas through one of the valves.

15. The method of claim 14 further including the final step of drawing a vacuum of at least 20 inches of mercury in the space between the tubes through one of the valves.

16. The method of claim 15 wherein said inert gas is nitrogen.
